(19) United States
(12) Patent Application Publication
(10) Pub. No.: US 2018/0090801 A1
(43) Pub. Date: Mar. 29, 2018

(54) Rescue Equipment Structure and Operation Method Thereof

(71) Applicant: National Kaohsiung University of Applied Sciences, Kaohsiung (TW)

(72) Inventor: Chun-Hsien Kuo, Kaohsiung (TW)

(21) Appl. No.: 15/462,970

(22) Filed: Mar. 20, 2017

(30) Foreign Application Priority Data
Sep. 29, 2016 (TW) 105131318

(51) Int. Cl. H01M 12/06; H01M 6/32; H01M 2/10; H01M 2/36

(52) U.S. Cl. CPC H01M 12/06; H01M 6/32; H01M 2220/30; H01M 2/361; H01M 2/365; H01M 2/1022

(57) ABSTRACT

A rescue equipment structure includes rescue equipment, a metal-air fuel cell set and a power consumption device. The metal-air fuel cell set is mounted to a first predetermined position of the rescue equipment and the power consumption device is mounted to the second predetermined position of the rescue equipment. A salt solution is added to the metal-air fuel cell to thereby supply power to the power consumption device.

### BACKGROUND OF THE INVENTION

### 1. Field of the Invention

The present invention relates to a rescue equipment structure and operation method thereof providing a function of emergency power supply. Particularly, the present invention relates to the rescue equipment structure having a metal-air fuel cell and operation method thereof.

### 2. Description of the Related Art

U.S. Pat. No. 9,028,990, entitled “Fuel cell emergency system,” discloses a fuel cell system for supplying emergency power to an aircraft. The fuel cell system includes a fuel cell, a hydrogen tank, an oxygen tank, and a power distribution unit. The fuel cell system provides for an emergency power supply for aircraft which is reliable, independent of the outside air, and has low maintenance needs.

U.S. Patent Application Publication No. 20100021778, entitled “Fuel cell emergency power system,” discloses fuel cell power systems. The fuel cell emergency power systems comprises a fuel cell having an anode and a cathode, a power distribution unit for selectively directing electrical current from the fuel cell to one or more consuming device, a hydrogen gas control system and an oxygen gas control system. The hydrogen gas control system includes a pressurized hydrogen tank providing hydrogen gas in selective fluid communication to the anode, a hydrogen gas-liquid water phase separator in downstream fluid communication with the anode, and a hydrogen recirculation pump for recirculating substantially liquid water-free hydrogen from the hydrogen gas-liquid water phase separator to the anode. Similarly, the oxygen gas control system includes a pressurized oxygen tank providing oxygen gas in selective fluid communication to the anode, an oxygen gas-liquid water phase separator in downstream fluid communication with the anode, and an oxygen recirculation pump for recirculating substantially liquid water-free oxygen from the oxygen gas-liquid water phase separator to the anode.

Another U.S. Patent Application Publication No. 20110187194, entitled “Emergency power supply system comprising a fuel cell,” discloses an emergency power supply system. The emergency power supply system for a load connected to an AC grid (normal grid) includes a fuel cell for generating direct current, an inverter for providing alternating current, and a controller. The controller includes a synchronizing means which synchronizes the current provided by the inverter in phase with the current of the AC grid. The emergency power supply system is able to again provide the normal grid to the loads without further interruption.

However, there is a need of improving and simplifying a conventional fuel cell power system for supplying emergency power to power-consuming devices. The above-mentioned patent and patent publications are incorporated herein by reference for purposes including, but not limited to, indicating the background of the present invention and illustrating the situation of the art.

As is described in greater detail below, the present invention provides a rescue equipment structure and operation method thereof. At least one or a plurality of metal-air fuel cells is mounted to rescue equipment and connects with a power-consumption device. In use, a salt solution is added to the metal-air fuel cell to supply power to a power consumption device in such a way as to mitigate and overcome the above problem.

### SUMMARY OF THE INVENTION

The primary objective of this invention is to provide a rescue equipment structure and operation method thereof. At least one or a plurality of metal-air fuel cells is mounted to rescue equipment and connects with a power-consumption device. In use, a salt solution is added to the metal-air fuel cell to supply power to a power consumption device. Advantageously, the rescue equipment structure and operation method of the present invention is successful in simplifying the entire structure and providing convenient use.

The rescue equipment structure in accordance with an aspect of the present invention includes:

rescue equipment having a first predetermined position and a second predetermined position;

at least one metal-air fuel cell set mounted to the first predetermined position of the rescue equipment; and

at least one power consumption device mounted to the second predetermined position of the rescue equipment;

wherein a salt solution is added to the metal-air fuel cell to thereby supply power to the power consumption device.

In a separate aspect of the present invention, the rescue equipment includes a life vest, a life ring, a life saving reach pole, a life surfboard, a life raft, a lifeboat, a buoyant apparatus, a first-aid kit, a float, a rescue tube, a buoy ball or a spine board.

In a further separate aspect of the present invention, the rescue equipment includes a socket to mount the metal-air fuel cell set.

In yet a further separate aspect of the present invention, the metal-air fuel cell set includes a sealing member for isolating the metal-air fuel cell set.

In yet a further separate aspect of the present invention, the sealing member is a protective cover, a protective film or a water soluble sealing member.

In yet a further separate aspect of the present invention, the metal-air fuel cell set connects with a back-up salt solution supply unit.

In yet a further separate aspect of the present invention, the power consumption device includes an illuminant device, an indicator, a signal transmitter or an alarm unit.

The operation method of rescue equipment in accordance with an aspect of the present invention includes:

providing a metal-air fuel cell set on a rescue equipment structure, with sealing the metal-air fuel cell set with a sealing member;

connecting a power consumption device to the metal-air fuel cell set, with mounting the power consumption device to the rescue equipment structure;

removing the sealing member from the metal-air fuel cell set in preparing emergency power to supply to the power consumption device; and

adding a predetermined amount of salt solution to the metal-air fuel cell set for supplying the emergency power to the power consumption device.

In a separate aspect of the present invention, the rescue equipment structure is formed from a life vest, a life ring, a life saving reach pole, a life surfboard, a life raft, a lifeboat, a buoyant apparatus, a first-aid kit, a float, a rescue tube, a buoy ball or a spine board.

In a further separate aspect of the present invention, the rescue equipment includes a socket to mount the metal-air fuel cell set.

In yet a further separate aspect of the present invention, the metal-air fuel cell set includes a sealing member for isolating the metal-air fuel cell set.

In yet a further separate aspect of the present invention, the sealing member is a protective cover, a protective film or a water soluble sealing member.

In yet a further separate aspect of the present invention, the metal-air fuel cell set connects with a back-up salt solution supply unit.

In yet a further separate aspect of the present invention, the power consumption device includes an illuminant device, an indicator, a signal transmitter or an alarm unit.

In yet a further separate aspect of the present invention, the salt solution is added to the metal-air fuel cell set via a salt solution filling hole.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a rescue equipment structure in accordance with a preferred embodiment of the present invention.

FIG. 2 is a flow chart of an operation method for rescue equipment in accordance with a preferred embodiment of the present invention.

FIG. 3 is a block diagram of a rescue equipment structure in accordance with another preferred embodiment of the present invention.

FIG. 4 is an exploded perspective view of a metal-air fuel cell structure applied in the rescue equipment in accordance with a first preferred embodiment of the present invention.

FIG. 5 is an assembled perspective view of the metal-air fuel cell structure applied in the rescue equipment in accordance with the first preferred embodiment of the present invention.

FIG. 6 is an exploded perspective view of a metal-air fuel cell structure applied in the rescue equipment in accordance with a second preferred embodiment of the present invention.

FIG. 7 is an assembled perspective view of the metal-air fuel cell structure applied in the rescue equipment in accordance with the second preferred embodiment of the present invention.

FIG. 8 is an exploded perspective view of a metal-air fuel cell structure applied in the rescue equipment in accordance with a third preferred embodiment of the present invention.

FIG. 9 is another exploded perspective view of the metal-air fuel cell structure in accordance with the third preferred embodiment of the present invention.

FIG. 10A is an assembled perspective view of unfolding the metal-air fuel cell structure in accordance with the third preferred embodiment of the present invention.

FIG. 10B is an assembled perspective view of shutting the metal-air fuel cell structure in accordance with the third preferred embodiment of the present invention.

### DETAILED DESCRIPTION OF THE INVENTION

It is noted that a rescue equipment structure and operation method thereof in accordance with the present invention is suitable for various types of metal-air fuel cells. The rescue equipment structure and operation method thereof can be applicable for various rescue vehicles, various rescue mechanical equipment or rescue electric machinery, for example, which are not limitative of the present invention.

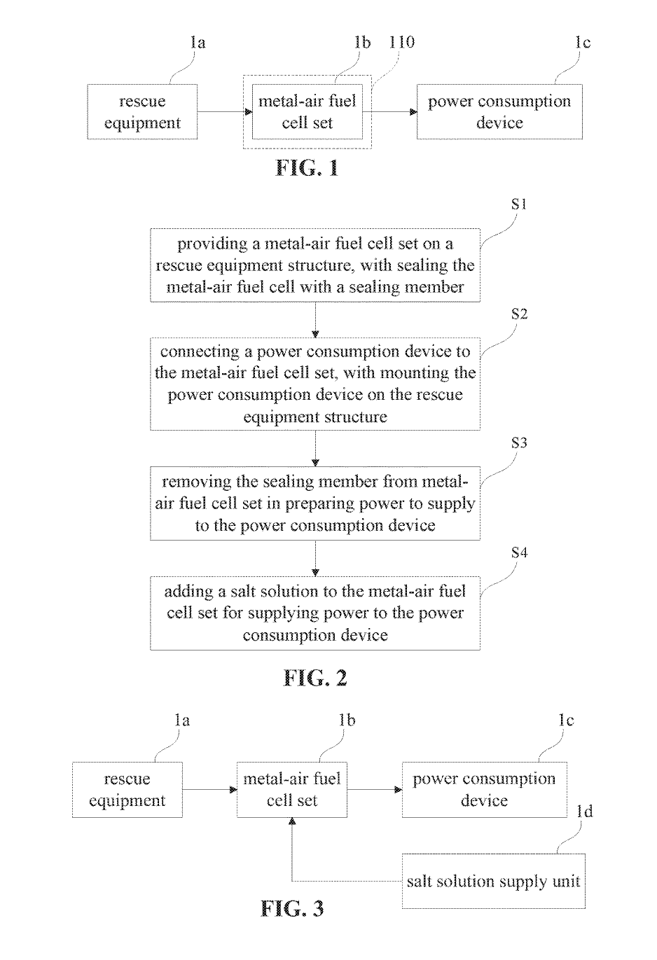

FIG. 1 shows a schematic block diagram of a rescue equipment structure in accordance with a preferred embodiment of the present invention. Referring now to FIG. 1, the rescue equipment structure of the preferred embodiment of the present invention includes rescue equipment 1a, a metal-air fuel cell set 1b and a power consumption device 1c. The metal-air fuel cell set 1b and the power consumption device 1c are provided to a surface or other suitable positions of the rescue equipment 1a.

With continued reference to FIG. 1, the rescue equipment 1a has a first predetermined position and a second predetermined position. The rescue equipment 1a is formed from a life vest, a life ring, a life saving reach pole, a life surfboard, a life raft, a lifeboat, a buoyant apparatus, a first-aid kit, a float, a rescue tube, a buoy ball, a spine board or other equivalent rescue equipment.

Still referring to FIG. 1, the metal-air fuel cell set 1b is mounted to the first predetermined position (e.g. recession or seat) of the rescue equipment 1a which further includes an adapter socket (as best shown in FIG. 5) or other equivalent socket to fixedly mount at least one or a series of the metal-air fuel cell sets 1b according to the needs.

With continued reference to FIG. 1, the metal-air fuel cell set 1b further includes a sealing member (dotted line in FIG. 1) 110 for isolating the metal-air fuel cell set 1b from exterior. By way of example, the sealing member is a protective cover, a protective film or a water soluble sealing member which is made of water soluble macromolecular material or other equivalent water soluble material.

Still referring to FIG. 1, the power consumption device 1c includes an illuminant device, an indicator, a signal transmitter or an alarm/warning unit (i.e. buzzer) and is mounted to the second predetermined position (e.g. top surface, outer circumferential surface) of the rescue equipment 1a. The metal-air fuel cell set 1b electrically connects with the power consumption device 1c. In emergency use, a predetermined amount of salt solution is added to the metal-air fuel cell set 1b for supplying emergency power to the power consumption device 1c.

FIG. 2 shows a flow chart of an operation method for rescue equipment in accordance with a preferred embodiment of the present invention, corresponding to the rescue equipment structure in FIG. 1. Referring now to FIGS. 1 and 2, the operation method for the rescue equipment of the preferred embodiment of the present invention includes the step S1 of: connecting the metal-air fuel cell set 1b on the first predetermined position of the rescue equipment 1c with a connector or the like, with sealing the metal-air fuel cell set 1b with the sealing member 110 for isolating it from exteriors.

With continued reference to FIGS. 1 and 2, the operation method for the rescue equipment of the preferred embodiment of the present invention includes the step S2 of: connecting the power consumption device 1c to the metal-air fuel cell set 1b, with mounting the power consumption device 1c or other back-up power consumption device to the second predetermined position (e.g. outer surface) of the rescue equipment 1a with a bundling strap or other equivalent member (e.g. Velcro bundling strap).

With continued reference to FIGS. 1 and 2, the operation method for the rescue equipment of the preferred embodiment of the present invention includes the step S3 of: removing or tearing off the sealing member 110 from the metal-air fuel cell set 1b in preparing emergency power to supply to the power consumption device 1c.

With continued reference to FIGS. 1 and 2, the operation method for the rescue equipment of the preferred embodiment of the present invention includes the step S4 of: adding a predetermined amount of salt solution to the metal-air fuel cell set 1b via a salt solution filling hole (as best shown in FIG. 5) for supplying the emergency power to the power consumption device 1c. By way of example, the salt solution is obtained from seawater collected from the sea or a dilute salt solution.

FIG. 3 shows a schematic block diagram of a rescue equipment structure in accordance with another preferred embodiment of the present invention, corresponding to that in FIG. 1. Turning now to FIG. 3, the rescue equipment structure of the present invention further includes a back-up salt solution supply unit 1d communicating with the salt solution filling hole of the metal-air fuel cell set 1b.

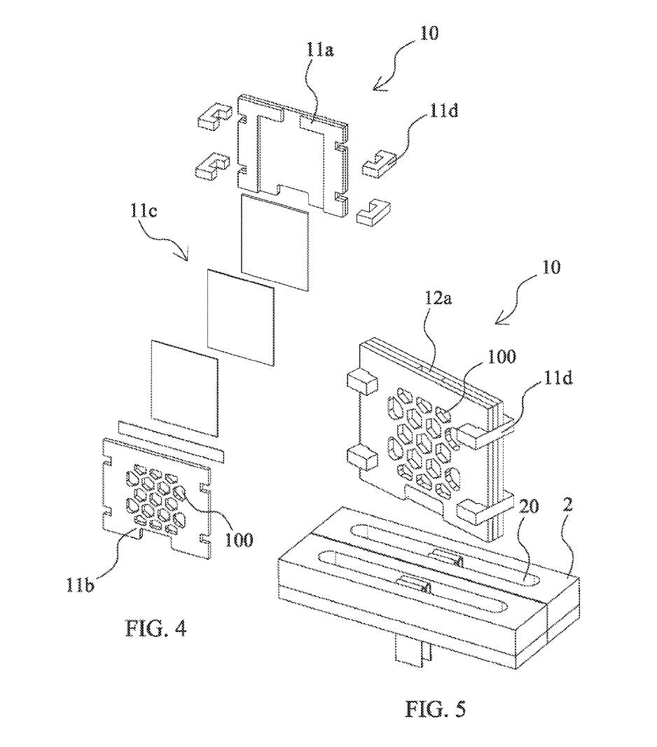

FIG. 4 is an exploded perspective view of a metal-air fuel cell structure applied in the rescue equipment in accordance with a first preferred embodiment of the present invention. FIG. 5 is an assembled perspective view of the metal-air fuel cell structure applied in the rescue equipment in accordance with the first preferred embodiment of the present invention. Turning now to FIGS. 4 and 5, the metal-air fuel cell of the first preferred embodiment includes a first casing member 11a and a second casing member 11b which are assembled and abutted each other to form an outer casing 10.

With continued reference to FIGS. 4 and 5, the first casing member 11a is made of an insulating material and is preferably formed as a first rectangular plate. The first casing member 11a is provided to arrange a plurality of metal-air fuel cell members 11c. By way of example, the metal-air fuel cell members 11c include a carbon paper (e.g. carbon cloth), a solution reservoir member (e.g. sponge or cloth), at least one metal plate (e.g. magnesium-aluminum alloy) and at least one or a plurality of electrode plates (e.g. copper plate).

With continued reference to FIGS. 4 and 5, the second casing member 11b is also made of an insulating material and is preferably formed as a second rectangular plate abutted against the first rectangular plate. The second casing member 11b is combined with the first casing member 11a to contain and isolate the metal-air fuel cell members 11c from exteriors.

With continued reference to FIGS. 4 and 5, the first casing member 11a and the second casing member 11b are formed from two sidewall casings which have an identical outline. The two sidewall casings have at least one or a plurality of fasteners 11d each of which is a C-shaped fastener or a clip. In assembling, assembling portions of the first casing member 11a and the second casing member 11b are clamped together with the fasteners 11d.

With continued reference to FIGS. 4 and 5, each bottom portion of the first casing member 11a and the second casing member 11b has a recessed edge to form an electrode hole. Extended in the electrode hole is a part of electrode plates for connecting with the adapter socket. In a preferred embodiment, a top edge of the first casing member 11a has a recessed portion to form a salt solution filling hole 12a communicated with the interior of the outer casing 10. Each of the first casing member 11a and the second casing member 11b has a plurality of ventilation holes 100 for ventilating the interior of the outer casing 10 with air to exteriors.

With continued reference to FIGS. 4 and 5, the outer casing 10 connects with a socket seat 2 for electrical connection therebetween. The socket seat 2 includes at least one or a series of sockets 20 in which to insert the outer casing 10 of the metal-air fuel cell according to the needs. The outer casings 10 of the metal-air fuel cell can be horizontally or vertically arranged and inserted into the sockets 20 of the socket seat 2.

With continued reference to FIGS. 4 and 5, the outer casing 10 is formed from a combination body of the first casing member 11a and the second casing member 11b between which to form an internal electrolyte container. A chemical reaction in the internal electrolyte container can generate electric power which supplies to the power consumption device 1c or a power source.

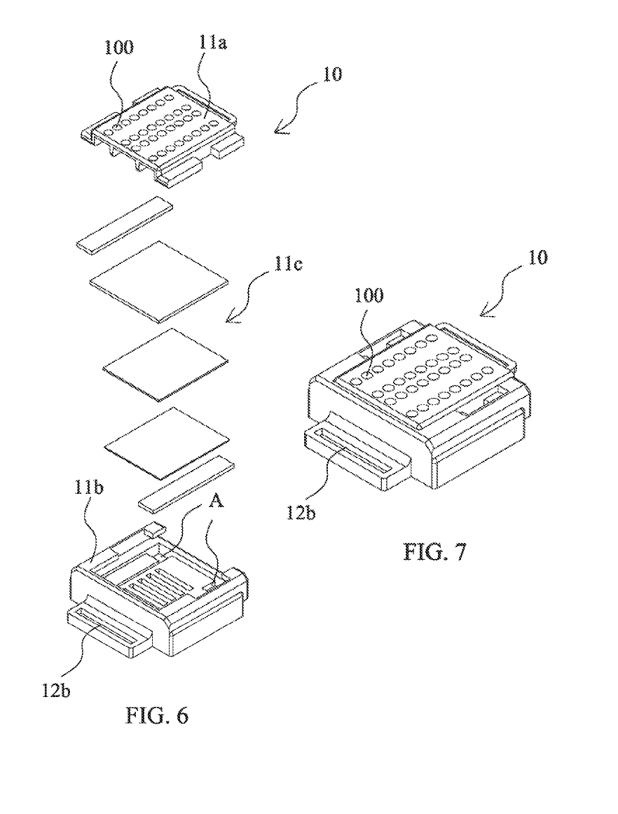

FIG. 6 is an exploded perspective view of a metal-air fuel cell structure applied in the rescue equipment in accordance with a second preferred embodiment of the present invention. FIG. 7 is an assembled perspective view of the metal-air fuel cell structure applied in the rescue equipment in accordance with the second preferred embodiment of the present invention. Turning now to FIGS. 6 and 7, the metal-air fuel cell of the second preferred embodiment includes a first casing member 11a formed as a cover plate and a second casing member 11b formed as a housing body on which to receive the cover plate. The housing body includes a bottom surface formed with a pair of electrode holes “A” in which to expose the electrode plates of the metal-air fuel cell members 11c. In a preferred embodiment, the housing body includes a pair of sidewalls each of which formed with an assembling slide track to receive the cover plate. In a preferred embodiment, the housing body further includes a side filling hole 12b which communicates with the interior of the outer casing 10.

With continued reference to FIGS. 6 and 7, in assembling, the cover plate of the first casing member 11a is pushed to slide along a direction of the assembling slide tracks of the housing body of the second casing member 11b for sealing an opening the housing body. In disassembling, the cover plate of the first casing member 11a is pushed to withdraw along a reverse direction of the assembling slide tracks of the housing body of the second casing member 11b.

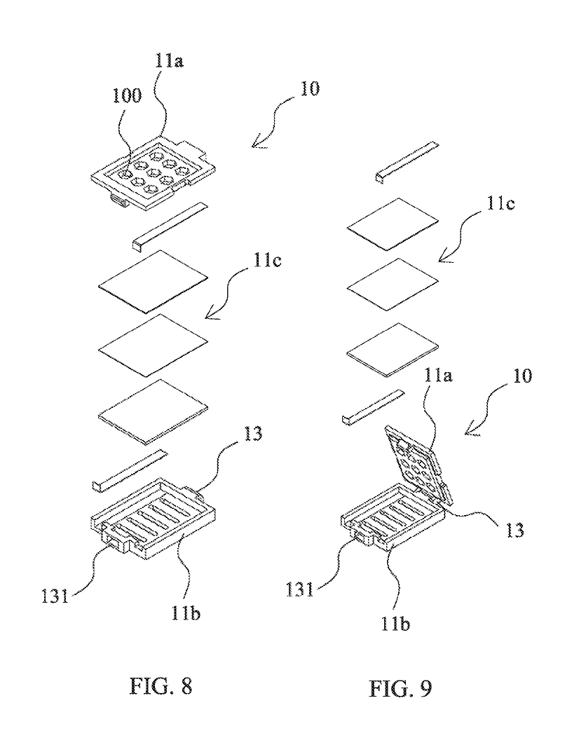

FIG. 8 is an exploded perspective view of a metal-air fuel cell structure applied in the rescue equipment in accordance with a third preferred embodiment of the present invention. FIG. 9 is another exploded perspective view of the metal-air fuel cell structure in accordance with the third preferred embodiment of the present invention. Turning now to FIGS. 6 and 7, the metal-air fuel cell of the second preferred embodiment includes a first casing member 11a formed with a first engaging portion and a second casing member 11b formed with a second engaging portion engaged therewith.

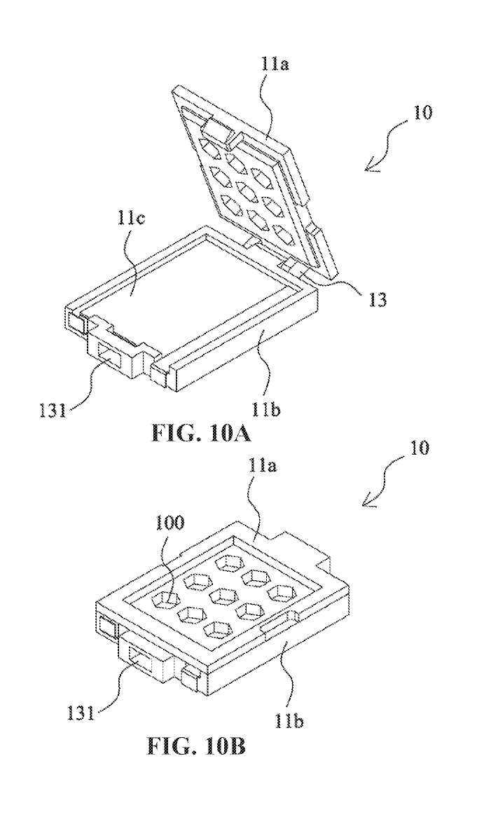

FIG. 10A is an assembled perspective view of unfolding the metal-air fuel cell structure in accordance with the third preferred embodiment of the present invention. Turning now to FIG. 10A, in unfolding, an edge of the first casing member 11a connects to that of the second casing member 11b with a hinge member 13.

FIG. 10B is an assembled perspective view of shutting the metal-air fuel cell structure in accordance with the third preferred embodiment of the present invention. Turning now to FIG. 10B, in closing, the first engaging portion of the first casing member 11a is engaged the second engaging portion of the second casing member 11b to seal the outer casing 10.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A rescue equipment structure comprising:
rescue equipment having a first predetermined position and a second predetermined position;
at least one metal-air fuel cell set mounted to the first predetermined position of the rescue equipment; and
at least one power consumption device mounted to the second predetermined position of the rescue equipment;
wherein a salt solution is added to the metal-air fuel cell to thereby supply power to the power consumption device.

2. The rescue equipment structure as defined in claim 1, wherein the rescue equipment includes a life vest, a life ring, a life saving reach pole, a life surfboard, a life raft, a lifeboat, a buoyant apparatus, a first-aid kit, a float, a rescue tube, a buoy ball or a spine board.

3. The rescue equipment structure as defined in claim 1, wherein the rescue equipment includes a socket to mount the metal-air fuel cell set.

4. The rescue equipment structure as defined in claim 1, wherein the metal-air fuel cell set includes a sealing member for isolating the metal-air fuel cell set.

5. The rescue equipment structure as defined in claim 4, wherein the sealing member is a protective cover, a protective film or a water soluble sealing member.

6. The rescue equipment structure as defined in claim 1, wherein the metal-air fuel cell set connects with a salt solution supply unit.

7. The rescue equipment structure as defined in claim 1, wherein the power consumption device includes an illuminant device, an indicator, a signal transmitter or an alarm unit.

8. An operation method of rescue equipment comprising:
providing a metal-air fuel cell set on a rescue equipment structure, with sealing the metal-air fuel cell set with a sealing member;
connecting a power consumption device to the metal-air fuel cell set, with mounting the power consumption device to the rescue equipment structure;
removing the sealing member from the metal-air fuel cell set in preparing emergency power to supply to the power consumption device; and
adding a predetermined amount of salt solution to the metal-air fuel cell set for supplying the emergency power to the power consumption device.

9. The operation method as defined in claim 8, wherein the rescue equipment structure is formed from a life vest, a life ring, a life saving reach pole, a life surfboard, a life raft, a lifeboat, a buoyant apparatus, a first-aid kit, a float, a rescue tube, a buoy ball or a spine board.

10. The operation method as defined in claim 8, wherein the rescue equipment includes a socket to mount the metal-air fuel cell set.

11. The operation method as defined in claim 8, wherein the metal-air fuel cell set includes a sealing member for isolating the metal-air fuel cell set.

12. The operation method as defined in claim 11, wherein the sealing member is a protective cover, a protective film or a water soluble sealing member.

13. The operation method as defined in claim 8, wherein the metal-air fuel cell set connects with a salt solution supply unit.

14. The operation method as defined in claim 8, wherein the power consumption device includes an illuminant device, an indicator, a signal transmitter or an alarm unit.

15. The operation method as defined in claim 8, wherein the salt solution is added to the metal-air fuel cell set via a salt solution filling hole.
